(19) United States
(12) Patent Application Publication
(10) Pub. No.: US 2007/0205013 A1
(43) Pub. Date: Sep. 6, 2007

(54) EQUIPMENT CAPABLE OF ADJUSTING HEIGHT THEREOF

(76) Inventor: Hsu-Hsin Huang, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/564,924

(22) Filed: Nov. 30, 2006

(30) Foreign Application Priority Data
Mar. 1, 2006 (TW) 095106721

(51) Int. Cl. H02G 3/14

(52) U.S. Cl. 174/66

(57) ABSTRACT

The invention discloses an equipment including a housing, a cover, and an adjusting member. The cover has a first edge and a second edge pivotally engaged to a first side of the housing. When the equipment is placed on a plane via a second side of the housing, the first side of the housing can be set at a height relative to the plane by rotating the cover to an open position, such that the equipment is placed on the plane via the second side of the housing and the first edge of the cover. Furthermore, when the equipment is placed on the plane, the height, corresponding to the open position, of the first side of the housing relative to the plane can be fine-tuned by rotating the adjusting member.

### BACKGROUND OF THE INVENTION

1. Field of the Invention

The invention relates to an equipment capable of adjusting its height, and more particularly to an equipment which utilizes a cover to adjust the height, so that the conventional adjuster foot is not required. Accordingly, the inner space of the equipment will increase, the size of the equipment will be reduced, and the cost will be also reduced.

2. Description of the Prior Art

When an equipment, such as a projector, is placed on a plane, the user may adjust the height of the equipment according to different needs. For example, when the user uses a projector to display images, he/she always desires to adjust the projected images to a position appropriate for watching. In general, most of the conventional projectors utilize the adjuster foot to adjust the height.

Referring to FIGS. 1A and 1B, FIG. 1A is a sectional view illustrating the adjuster foot 10 of the prior art. FIG. 1B is a sectional view illustrating the button 12 being released from the adjuster foot 10 shown in FIG. 1A. As shown in FIG. 1A, the adjuster foot 10 comprises a button 12, an engaging member 14, a screw rod 16, and a fixed base 18. The screw rod 16 has lots of threads thereon, and the engaging member 14 has lots of grooves capable of cooperating with the thread pitch of the screw rod 16. When the adjuster foot 10 is in a closed position, the grooves of the engaging member 14 will engage with the threads of the screw rod 16, as shown in FIG. 1A. When the user wants to adjust the height of the projector (not shown), he/she only needs to press the button 12, so as to move the engaging member 14 away from the screw rod 16, as shown in FIG. 1B. In other words, the user can adjust the height of the projector by the screw rod 16. However, the conventional adjuster foot has some drawbacks as listed below:

1. The structure of the conventional adjuster foot is complicated, and the cost is high.

2. In the interior of the projector, there must be a space to accommodate the adjuster foot.

3. The engaging member 14 has to cooperate with the screw rod 16 precisely, or the mechanism may lose the desired function.

Therefore, the scope of the invention is to provide an equipment capable of adjusting its height to solve the above-mentioned problems.

### SUMMARY OF THE INVENTION

A scope of the invention is to provide an equipment capable of adjusting its height. The equipment utilizes a cover to adjust its height. Furthermore, at least one adjusting member is mounted on one of the two sides of the cover near an upper edge (first edge) of the cover to fine-tune the height of the equipment.

According to a preferred embodiment of the invention, the equipment comprises a housing, a cover, and at least one adjusting member. The housing has a first side and a second side adjacent to the first side. The cover has a first edge and a second edge opposite to the first edge. The cover is pivotally engaged to the first side of the housing via the second edge. The first edge of the cover can be located at a closed position relative to the first side of the housing, such that the cover covers the first side of the housing. The cover can also be operated to rotate to one of a plurality of open positions relative to the first side of the housing.

When the equipment is placed on a plane via the second side of the housing, the first side of the housing is capable of being set at a height, corresponding to one of the open positions, relative to the plane by rotating the cover to the open position, such that the equipment is placed on the plane via the second side of the housing and the first edge of the cover.

Furthermore, when the first edge of the cover is rotated to one of the open positions, the equipment is placed on the plane via the second side of the housing and the first edge of the cover, and the height, corresponding to the open position, of the first side of the housing relative to the plane is capable of being fine-tuned by rotating the adjusting member.

Therefore, the invention not only adjusts the height of the equipment by the cover but also fine-tunes the height by the adjusting member, such that the user can adjust the height of the equipment quickly and precisely. Moreover, since in the invention the conventional adjuster foot is not required, the inner space of the equipment will increase, the size of the equipment will be reduced, and the cost will be also reduced.

The advantage and spirit of the invention may be understood by the following recitations together with the appended drawings.

### BRIEF DESCRIPTION OF THE APPENDED DRAWINGS

FIG. 1A is a sectional view illustrating the adjuster foot of the prior art.

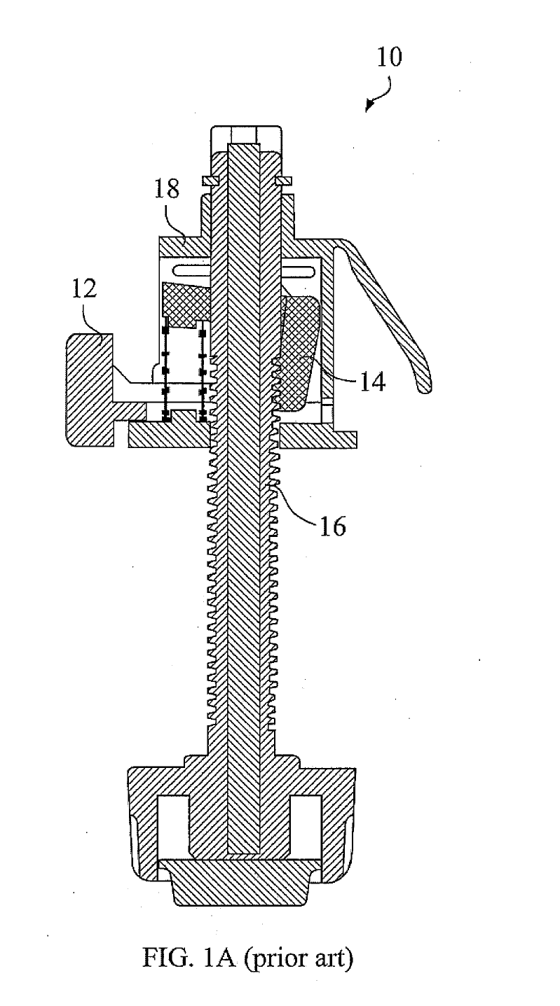

FIG. 1B is a sectional view illustrating the button being released from the adjuster foot shown in FIG. 1A.

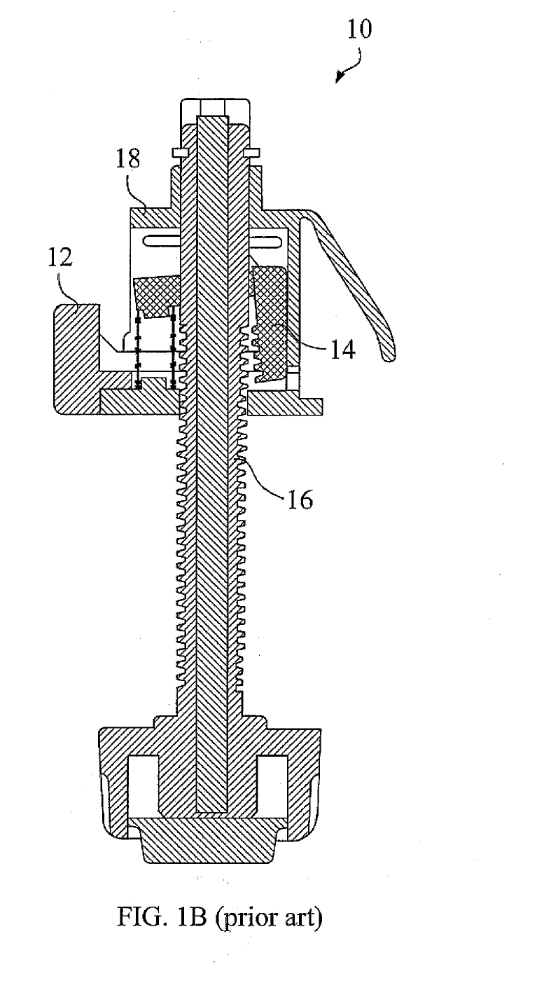

FIG. 2A is a perspective view illustrating the equipment according to a first preferred embodiment of the invention.

FIG. 2B is a perspective view illustrating the cover (shown in FIG. 2A) being opened to adjust the height of the equipment.

FIG. 2C is a side view illustrating the equipment shown in FIG. 2B.

FIG. 3 is a front view illustrating the eccentric wheel shown in FIG. 2C.

### DETAILED DESCRIPTION OF THE INVENTION

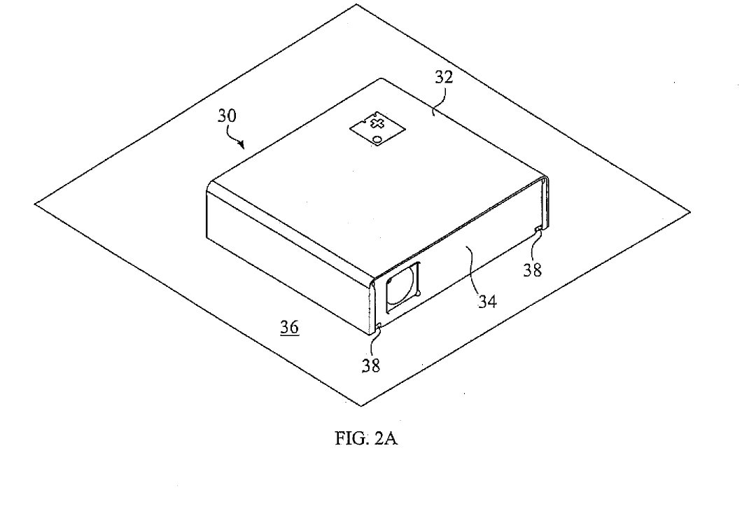

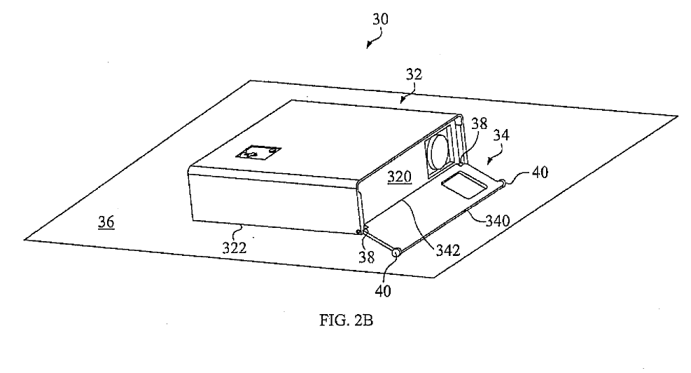

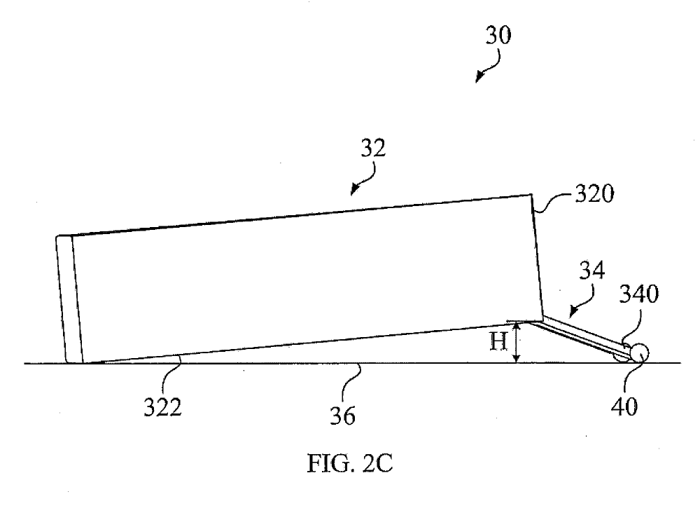

Referring to FIGS. 2A through 2C, FIG. 2A is a perspective view illustrating the equipment 30 according to a first preferred embodiment of the invention. FIG. 2B is a perspective view illustrating the cover 34 (shown in FIG. 2A) being opened to adjust the height of the equipment 30. FIG. 2C is a side view illustrating the equipment 30 shown in FIG. 2B. As shown in FIG. 2A, the equipment 30 of the invention comprises a housing 32 and a cover 34. As shown in FIG. 2B, the housing 32 has a first side 320 and a second side 322 adjacent to the first side 320. The cover 34 has a first edge 340 and a second edge 342 opposite to the first edge 340. The cover 34 is pivotally engaged to the first side 320 of the housing 32 via the second edge 342. The first edge 340 of the cover 34 can be located at a closed position relative to the first side 320 of the housing 32, such that the cover 34 covers the first side 320 of the housing 32, as shown in FIG. 2A. The cover 34 is also capable of being operated to rotate to one of a plurality of open positions relative to the first side 320 of the housing 32.

When the equipment 30 is placed on a plane 36 via the second side 322 of the housing 32, the first side 320 of the housing 32 can be set at a height H, corresponding to one of the open positions, relative to the plane 36 by rotating the cover 34 to the open position, such that the equipment 30 is placed on the plane 36 via the second side 322 of the housing 32 and the first edge 340 of the cover 34, as shown in FIG. 2C. In this embodiment, the cover 34 is pivotally engaged to the first side 320 of the housing 32 by two hinges 38 via the second edge 342, such that the cover 34 can be fixed at any specific open positions, as shown in FIG. 2B. Accordingly, in the invention the conventional adjuster foot is not required, so the inner space of the equipment will increase, the size of the equipment will be reduced, and the cost will be also reduced.

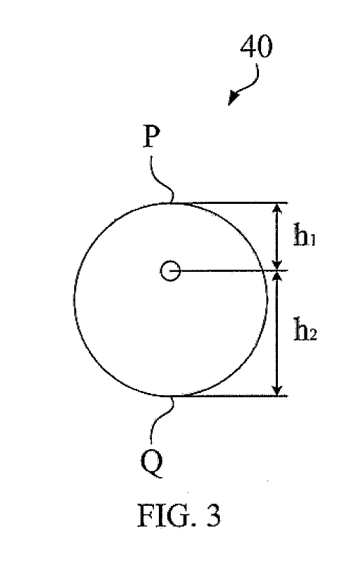

Referring to FIG. 3, FIG. 3 is a front view illustrating the eccentric wheel 40 shown in FIG. 2C. The equipment 30 of the invention further comprises two adjusting members. The adjusting member may be an eccentric wheel, a cam, or the like. In the aforesaid embodiment, the equipment 30 comprises two eccentric wheels 40, wherein each eccentric wheel 40 can be rotatably mounted on one of the two sides of the cover 34 and near the first edge 340, as shown in FIG. 2B. When the first edge 340 of the cover 34 is rotated to one of the open positions, the equipment 30 is placed on the plane 36 via the second side 322 of the housing 32 and the first edge 340 of the cover 34, and the height H, corresponding to the open position, of the first side 320 of the housing 32 relative to the plane 36 can be fine-tuned by rotating each of the eccentric wheels 40 respectively.

As shown in FIG. 3, when each of the eccentric wheels 40 is rotated from point P and point Q respectively, there will be a height difference (h₂−h₁), and the user can fine-tune the height of the first side 320 of the housing 32 relative to the plane 36. Accordingly, the user can adjust the height of the equipment 30 quickly and precisely. The eccentric wheel 40 can be limited to rotate in a discontinuous manner, such that when the user tunes the height of the housing 32 to a specific height, the eccentric wheel 40 will stop at the specific height. In other words, the height will not be changed until the user rotates the eccentric wheel 40 again.

In the aforesaid embodiment, the equipment 30 of the invention may further comprise at least one auxiliary supporting member (not shown in the figures). Each of the auxiliary supporting members corresponds to one of the eccentric wheels 40 and is operatively engaged between the eccentric wheel 40 and the cover 34, so as to assist the eccentric wheel 40 to rotate relative to the cover 34. The auxiliary supporting member may be a pre-set contact force spring or the like.

Compared to the prior art, the invention not only adjusts the height of the equipment by the cover but also fine-tunes the height by the adjusting member (e.g. an eccentric wheel, cam, etc.), such that the user can adjust the height of the equipment quickly and precisely. Moreover, since in the invention the conventional adjuster foot is not required, the inner space of the equipment will increase, the size of the equipment will be reduced, and the cost will be also reduced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An equipment capable of adjusting height thereof, comprising:
a housing having a first side and a second side adjacent to the first side; and
a cover having a first edge and a second edge opposite to the first edge, the cover being pivotally engaged to the first side of the housing via the second edge, the first edge of the cover being capable of being located at a closed position relative to the first side of the housing, such that the cover covers the first side of the housing, the cover being also capable of being operated to rotate to one of a plurality of open positions relative to the first side of the housing;
wherein when the equipment is placed on a plane via the second side of the housing, the first side of the housing is capable of being set at a height, corresponding to the open position, relative to the plane by rotating the cover to the open position, such that the equipment is placed on the plane via the second side of the housing and the first edge of the cover.

2. The equipment of claim 1, further comprising:
an adjusting member capable of being rotatably mounted on one of the two sides of the cover and near the first edge;
wherein when the first edge of the cover is rotated to the open position, the equipment is placed on the plane via the second side of the housing and the first edge of the cover, and the height, corresponding to the open position, of the first side of the housing relative to the plane is capable of being tuned by rotating the adjusting member.

3. The equipment of claim 2, wherein the adjusting member is an eccentric wheel.

4. The equipment of claim 2, wherein the adjusting member is a cam.

5. The equipment of claim 2, wherein the adjusting member is rotated in a discontinuous manner.

6. The equipment of claim 2, further comprising an auxiliary supporting member corresponding to the adjusting member and being operatively engaged between the adjusting member and the cover to assist the adjusting member rotating relative to the cover.

7. The equipment of claim 6, wherein the auxiliary supporting member is a pre-set contact force spring.

8. The equipment of claim 1, wherein the cover is pivotally engaged to the first side of the housing by a hinge via the second edge.
